(19) United States
(12) Patent Application Publication
(10) Pub. No.: US 2015/0301336 A1
(43) Pub. Date: Oct. 22, 2015

(54) AUGMENTED-REALITY OPTICAL MODULE

(71) Applicant: LASTER, Les Ulis Cedex (FR)

(72) Inventors: Maxime DENEFLE, Le Kremlin-Bicetre (FR); Zile LIU, Evry (FR)

(21) Appl. No.: 14/646,588

(22) PCT Filed: Nov. 21, 2013
(86) PCT No.: PCT/FR2013/052812

§ 371 Date: May 21, 2015

(30) Foreign Application Priority Data
Nov. 21, 2012 (FR) 1261080

(51) Int. Cl. G02B 27/01; G02B 5/30; G06T 19/00; G02B 27/28; G02B 27/00

(52) U.S. Cl. CPC G02B 27/0101; G02B 27/281; G02B 27/0093; G02B 27/0172; G06T 19/006; G02B 5/30; G02B 2027/0116; G02B 2027/0118; G02B 2027/0138; G02B 2027/0178; G02B 2027/0132

(57) ABSTRACT

The augmented-reality optical device (1) includes: a display (2) for emitting at least one image in the form of a beam; an optical surface (4) arranged essentially transversely to the main optical axis such that it deflects the image towards the eye; a semi-reflective plate (3) for deflecting the image between the display and the optical surface; and a polarizer (6) for eliminating the parasite light.

The present invention relates mainly to the field of portable augmented-reality optical devices, in particular those mounted on the head of a user.

There currently exist numerous solutions for viewing an image by means of a display system mounted on the head of a user. The majority of these devices do not allow vision by transparency and cannot therefore be integrated in an augmented-reality system without substantially reducing the natural field of vision of the user, which represents approximately 180° for the natural horizontal field of view and 120° for the natural vertical field of view.

Some optical solutions are transparent but use an “off-axis” optical path, that is to say outside the main vision axis of the user, which gives rise to high optical aberrations, in particular astigmatism, field curvature and distortion, which reduces the quality of the image projected into the retina. In order to compensate for these aberrations, these devices use a certain number of optical elements that are not compatible with the thinness required for a device that it is wished to be able to integrate in a pair of ergonomic spectacles.

Another problem with the current devices concerns the size of the exit aperture. The pupil of an eye looking at a projected image of average intensity is approximately 3 mm in diameter. In order to have an ergonomic display system, the exit aperture, that is the region for placing the eye where the user perceives the whole of the field, must be at least three times larger than the pupil of the eye of the user so that, even if the user moves with respect to the system, he continue to perceive a sharp image without vignetting.

The aim of the invention is in particular to propose a device wherein the size and complexity are appreciably reduced compared with existing display systems and designed so that it can be fixed to the head of a user while remaining transparent for his gaze. Furthermore, such a device will advantageously be easy to use for general-public applications where ergonomics and simplicity are key elements.

According to the invention, such an augmented-reality device is characterised in that it comprises:

a display for emitting at least one image in the form of a beam;

means for positioning said display laterally relative to an eye of a user, so that said display emits said image substantially transversely relative to a principal optical axis of said eye;

an ocular return sight, disposed substantially transversely to said principal optical axis so that it returns the image in the direction of the eye;

means for redirecting said image between said display and said sight; and

polarisation means for eliminating stray light.

This device may further comprise ophthalmic correction means for adapting the image to the vision of the user.

The display is preferably chosen from the LCD, OLED and LCOS types. The device may further comprise at least one lens or a group of lenses disposed downstream of the display and upstream of the redirection means, in particular to obtain the required magnification of the image, preferably by compensating for chromatic aberrations.

The redirection means are advantageously a semi-reflective flat or curved blade, designed to bend the image beam issuing from the display in the direction of an internal face of the sight, said blade allowing at least part of the beam reflected by said sight to pass without reflection. This semi-reflective blade comprises a polarising structure able to fulfil the functions of reflection and transmission of said blade on the one hand and on the other hand to significantly reduce the interfering reflections due to the light coming from the other side of said blade.

It may also comprise a microcamera the axis of which is placed substantially parallel to the optical axis of the directing eye of the user, an inertial unit, a magnetic compass and a GPS to provide virtual interaction with the environment observed in augmented reality according to the movements and point of view of the user. Preferably, the device also comprises a battery and electronic computing and communication means designed to allow wireless use with a smartphone or a computer.

The invention also relates to an augmented-reality optical system characterised in that it comprises two augmented-reality optical devices according to the invention, each for a respective eye of the user.

A device, or system, according to the invention advantageously comprises a carrier structure to fix it to the head of the user, preferably of the spectacle frame, ski mask, protective mask or helmet type.

Several embodiments of the invention will be described below, by way of non-limitative examples, with reference to the accompanying drawings, in which:

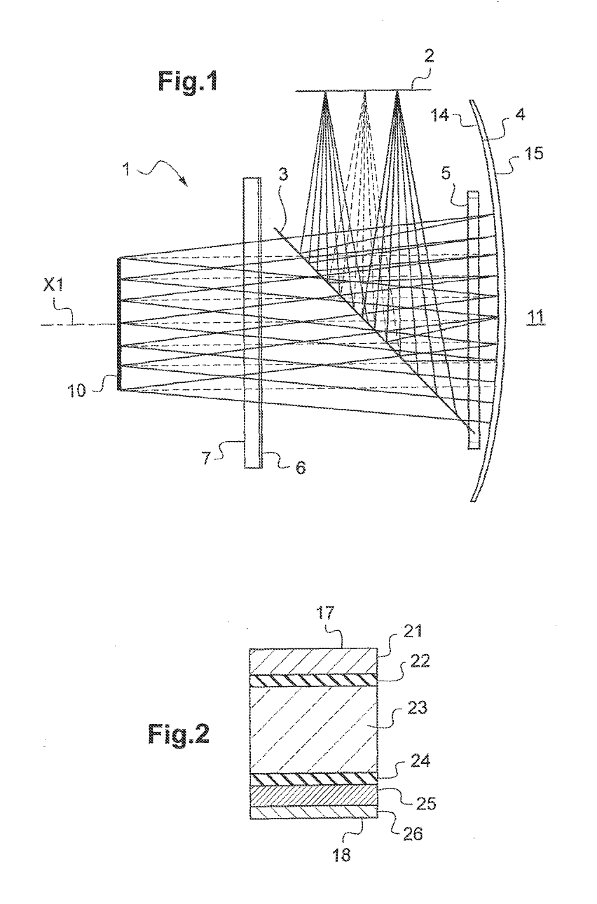

FIG. 1 illustrates schematically a vertical axial section of a device according to the invention; and

FIG. 2 illustrates a cross section through the thickness of a semi-reflective plate for the device in FIG. 1.

FIG. 1 uses a portable optical device 1 intended to procure augmented reality for a user of this device. This device is in a so-called “on the axis” optical configuration, that is to say along an optical axis X1 that is substantially the axis of the gaze of the user when he is looking to infinity, in front of him; this reduces the complexity and weight of such a device. In the example illustrated, this device 1 comprises a display 2, a semi-reflective plate 3, a sight 4, a retarding plate 5, a polarising film 6 and ophthalmic correction means 7.

The display 2 may be of the LCOL, LCD or OLED microdisplay type; it is intended to form and emit an image, fixed or moving, in the form of a light beam. The reflective plate 3 is of the PBS (polarising beam splitter) type and is used for bending the optical path of the light beam issuing from the display 2 in the direction of the sight 4. The sight 4 is a semi-transparent catadioptric element intended to collimate the beam so as to project the image to infinity in the eye 10 of the users. The retarding plate 5 is a polarised plate of the quarter-wave type.

The plate 3 is transparent to p-polarised light, that is to say polarised in the instant plane, and reflects s-polarised light, that is to say perpendicular to the incident plane, when it is positioned at 45 degrees with respect to the optical axis X1. The display 2 comprises polarisation means or is juxtaposed with a polariser, so that the light emitted is s-polarised, so that it is reflected by the reflective plate 3. Once reflected by the reflective blade 3, it passes through the retarding plate 5, which converts the s-polarisation of the light into a circular polarisation. The reflection on the semi-reflective mirror formed by the sight 4 reverses the orientation of the circular polarisation and the second passage through the quarter-wave plate converts the light into p-polarisation; thus the semi-reflective plate 3 becomes totally transparent to the light returned by the sight 4, when this light passes through it again in the direction of the eye of the user.

An assembly, not shown in the figures, consisting of optical lenses coupled with a semi-reflective catadioptric element, and intended to obtain the required magnification while compensating for chromatic aberrations, is disposed immediately downstream of the display 2.

Thus the optical path travelled by an image emitted by the diffuser 2 can be described as follows:
Display 2→lens assembly

→semi-reflective plate 3

→¼-wave plate 5

→sight 4

→¼-wave plate 5

→semi-reflective plate 3

→polariser 6

→correction means 7→eye 10

The optical path travelled by a scene 11 observed by the user through the device 1 can be described as follows:
Scene 11→sight 4

→¼-plate 5

→semi-reflective plate 3

→polariser 6

→correction means 7→eye 10

The use of a semi-reflective plate 3 of the PBS type, instead of a plate of the semi-reflective mirror type, significantly increases the brightness of the device when the display is of the LCD or LCOS type. The transmission ratio of the light for the optical path of the device in FIG. 1 is 77% with a PBS plate as against 25% with a semi-reflective mirror. A semi-reflective mirror can nevertheless be used for an architecture at lower cost.

The use, for the sight 4, of a semi-reflective catadioptric element 4 in the frontal position compensates for spherical aberrations and does not add any prismatic or distortion effect when the user looks through the device. The advantage of such catadioptric elements is the possibility of using large diameters without increasing chromatic aberrations as with reflective elements. The use of a spherical or aspherical sight coupled with the semi-reflective flat or curved plate also significantly increases the displayable field. The sight 4 is preferably manufactured from polycarbonate with a semi-reflective internal surface 14, which can be, in order to optimise the performances thereof. The internal transmission of the sight 4 is optimised in order to guarantee good contrast between the projected image and the scene 11 observed. A semi-reflective holographic treatment can be used in place of the thin-layer semi-reflective treatment so as to improve the brightness of the projected images in the case of the projection of a monochromatic or RGB image. The external face 15 of the sight 4 is calculated so as to cancel the prismatic effects for vision in transparency, and thus the natural vision of the scene 11 is preserved.

The retarding plate 5 can take the form of a polymer film. In order to facilitate the assembly of the device, it may be thermoformed in order to adapt directly to the curvature of the sight 4.

The geometry and curvature of the internal surface 14 of the sight 4 and those of the lenses of the assembly coupled with the diffuser can be optimised in order to adapt the magnification of the optical system to various screen sizes of the diffuser 2.

FIG. 2 illustrates a cross section through the thickness of the semi-reflective plate 3. In the example illustrated, from a first face 17 turned towards the display 2 and the sight 4, and a second face 18 turned towards the eye 10 of the observer, the plate 3 comprises six layers 21-26, namely:
a polarising and reflective structure 21, consisting of a film of the WGF type;
an adhesive 22 for the first layer 21 on the third layer 23;
a polymer substrate 23, for example PMMA or polycarbonate;
an adhesive 24 for the fifth layer 25 on the third layer 23;
a layer formed by a linear polariser 25 with a high coefficient of transmission; and
a non-reflective coating 26.

Any stray light issuing from the bottom of the device (reflection on the semi-reflective plate 3) passes through the non-reflective coating 26, the s-polarisation is absorbed by the polarising film 25, and the residual p-polarisation passes through the substrate 23 without being reflected by the

WGF film, which transmits the p-polarisation and reflects the s-polarisation. In this way stray light of this type is no longer reflected in the direction of the eye 10 of the user.

The polariser 6, although not essential, may be placed on the path between the semi-reflective plate 3 and the eye 10 of the user in order advantageously to filter the non-p-polarised part of the light issuing from interfering reflection on the semi-reflective plate 3 if the latter does not comprise the structure 17. In the example illustrated in FIG. 1, the polariser 6 is a film advantageously deposited on the correction means 7, adapting the image to the vision of the user.

A device such as the one in FIG. 1 is very compact, the eye relief being 15 mm; the complete device 1 may have a size of 30×25×17 mm; it can for example be completely integrated in a pair of ergonomic sunglasses. Furthermore, a device according to the invention represents an improvement compared with the prior art by virtue of the use of a semi-reflective plate coupled with a semi-reflective spherical front surface 14 that significantly reduces the aberrations and vignetting of the natural field of vision. The exit aperture is also easily increased from 9 mm to 15 mm in diameter depending on the versions of the architecture. With an exit aperture with a diameter greater than 9 mm, such an optical device 1 can be used in pairs so as to produce a small augmented-reality binocular device. This system would be for example easily compatible for a population set with an IPD (interpupillary distance) of between 52 and 65 mm without requiring any adjustment.

The microdisplay 1 is located on top so that the natural field of vision of the user is preserved; natural HFOV (horizontally) of at least 160° and VFOV (vertically) greater than 100° are taken into account. The device 1 does not reduce the natural field of vision while having a small aspect ratio and can therefore be used in a large number of applications where the scene perceived is as important as the information or images projected.

The device can advantageously be coupled to a microcamera or movement sensors connected to the head of the user (gyroscopes, accelerometers, etc.) so as to interact with the scene observed. Other options such as voice recognition, an inertial unit or a location device (GPS etc.) can be added in order to improve the immersion and experience of the user.

Naturally the invention is not limited to the examples that have just been described.

Thus the device may not comprise ophthalmic correction means. Where correction is used, the eye relief is reduced by a few mm. The correction may be applied directly to the front semi-reflective glass or by adding ophthalmic clips.

Thus the choice of the display used among the LCD, OLED or LCOS types is made according to the requirements of the application sought, in terms of brightness, colour rendering and costs.

Instead of the optical lens assembly coupled to a semi-reflective catadioptric element intended to obtain the required magnification while compensating for chromatic aberrations, these lenses may be replaced by hybrid lenses coupled with a Fresnel lens. In the case of mass production, these components can be moulded in polycarbonate in order to optimise cost.

Instead of being above the optical axis of the eye of the user, the display may be disposed laterally relative to this axis, for example on one side or below.

1. Augmented-reality optical device (1), which comprises:
a display (2) for emitting at least one image in the form of a beam;
means for positioning said display laterally relative to an eye (10) of a user, so that said display emits said image substantially transversely relative to a principal optical axis (X1) of said eye;
an ocular return sight (4), disposed substantially transversely to said principal optical axis so that it returns the image in the direction of the eye;
means (3) for redirecting said image between said display and said sight; and
polarisation means (6, 21, 25) for eliminating stray light.

2. Device according to claim 1, further comprising ophthalmic correction means (7) for adapting the image to the vision of the user.

3. Device according to claim 1, wherein the display is chosen from the LCD, OLED and LCOS types.

4. Device according to claim 1, further comprising at least one lens or a group of lenses disposed downstream of the display and upstream of the redirection means, in particular in order to obtain the required magnification of the image, preferably while compensating for chromatic aberrations.

5. Device according to claim 1, wherein the redirection means are a semi-reflective plate (3), designed to bend the image beam issuing from the display (2) in the direction of an internal face (14) of the sight (4), said blade (3) allowing at least part of the beam reflected by said sight to pass without reflection.

6. Device according to claim 5, wherein the semi-reflective plate comprises a polarising structure (21) able to fulfil the functions of reflection and transmission of said plate on the one hand and on the other hand to significantly reduce the interfering reflections due to the light coming from the other side of said plate.

7. Device according to claim 1, further comprising a microcamera, the axis of which is placed substantially parallel to the optical axis of the directing eye of the user, an inertial unit, a magnetic compass and a GPS in order to allow virtual interaction with the environment observed in augmented reality according to the movements and point of view of the user.

8. Device according to claim 1, further comprising a battery and electronic computing and communication means designed to allow wireless use with a smartphone or computer.

9. Device according to claim 1, further comprising a carrier structure for fixing it to the head of the user, preferably of the spectacle frame, ski mask, protective mask or helmet type.

10. Augmented-reality optical system, which comprises two augmented-reality optical devices (1) according to claim 1, each for a respective eye of the user.
